(19) United States
(12) Patent Application Publication
(10) Pub. No.: US 2008/0088473 A1
(43) Pub. Date: Apr. 17, 2008

(54) RFID SYSTEM AND METHOD FOR CONTROLLING DISTANCE RANGES

(75) Inventors: Hyun Chul Kim, Busan (KR); Hyun Chul Lee, Busan (KR); Dong Ho Yoo, Busan (KR); Hyun Deuk Choi, Busan (KR); Chang Sup Lee, Busan (KR)

Correspondence Address: HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: KPC INC., Busan (KR)

(21) Appl. No.: 11/621,772

(22) Filed: Jan. 10, 2007

(30) Foreign Application Priority Data
Oct. 17, 2006 (KR) KR 10-2006-100906

(51) Int. Cl. G08B 1/00

(52) U.S. Cl. 340/825.37

(57) ABSTRACT

Disclosed herein is a Radio Frequency Identification (RFID) system and method for controlling distance ranges. The RFID system includes a plurality of RFID tags, a plurality of readers, and middleware. The RFID tags receive position coordinates and time data through signals from a satellite and store data. The readers transmit and receive data to and from the RFID tags. The middleware forms a network in conjunction with the readers and controls distance ranges between the RFID tags and the readers.

### BACKGROUND OF THE INVENTION

1. Field of the Invention

The present invention relates generally to a Radio Frequency Identification (RFID) system and method for controlling distance ranges and, more particularly, to an RFID system for controlling distance ranges, including a plurality of RFID tags for receiving position coordinates and time data through signals from a satellite and storing data, a plurality of readers for transmitting and receiving data to and from the RFID tags, and middleware configured to form a network in conjunction with the readers and control a distance range between the RFID tags and the readers, and a method of controlling the distance range.

2. Description of the Related Art

Korean Unexamined Patent Publication No. 10-2006-0066923 discloses a prior art RFID-based entrance control system and method, which includes a plurality of gate antennas installed on the gate of a building for which entrance control is desired, and configured to receive tag information from an RFID tag; an Access Point (AP) installed on the gate of the building and configured to receive radio signals, corresponding to the tag information, from a transportation means on which a person for whom entrance control is desired is riding; an RFID reader for controlling the operation of the gate antennas and converting the tag information, received by the gate antennas, into tag data; an agent for determining the entrance status of the RFID tag by analyzing the tag data received from the RFID reader; and a guidance server for storing the entrance information of the RFID tag received from the agent and the tag information received from the AP and performing entrance control on the person for whom entrance control is desired based on the RFID tag entrance information stored in the database.

However, the prior art technology is problematic in that the signals of the plurality of gate antennas overlap each other, therefore it is difficult to obtain correct information from tags. Meanwhile, the signals of the gate antennas must be controlled according to the environment or operational conditions in order to obtain correct information necessary for the operation of the RFID system. The prior art technology is problematic in that it is impossible for an operator to freely control the signals of the gate antennas, and thus the operator must request a reader manufacturer to set the distance ranges of the signals when necessary.

### SUMMARY OF THE INVENTION

Accordingly, the present invention has been made keeping in mind the above problems occurring in the prior art, and an object of the present invention is to provide an RFID system and method for controlling distance ranges, which can freely control signals exchanged between a plurality of readers and RFID tags through middleware, therefore the correct information of the RFID tag can be collected and the performance of an RFID system is improved.

In order to accomplish the above object, the present invention provides an RFID system for controlling distance ranges, including a plurality of RFID tags for receiving position coordinates and time data through signals from a satellite and storing data; a plurality of readers for transmitting and receiving data to and from the RFID tags; and middleware configured to form a network in conjunction with the readers and control distance ranges between the RFID tags and the readers.

Additionally, in order to accomplish the above object, the present invention provides a method of controlling distance ranges, including a first step of a reader waiting for execution of a command transmitted from middleware; a second step of the middleware issuing an RF output control command to the reader; a third step of authenticating the reader's ID and password so as to execute the RF output control command received from the middleware; a fourth step of setting the reader's RF output value if the authentication is successful; a fifth step of determining whether the RF output value set for the reader is identical to a RF output control command transmitted from the middleware; and a sixth step of making an approval response if the reader's RF output value is identical to the RF output control command transmitted from the middleware.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of an RFID system capable of controlling a distance range according to an embodiment of the present invention;

FIG. 2 is a detailed diagram showing the RFID tag of FIG. 1 according to the present invention;

FIG. 3 is a detailed diagram showing the reader of FIG. 1 according to the present invention;

FIG. 4 is a detailed diagram showing the activation module of FIG. 3 according to the present invention;

FIG. 5 is a diagram showing the operation of the middleware and the reader based on FIG. 3; and

FIG. 6 is a flowchart showing a method of controlling distance ranges according to another embodiment of the present invention.

### DESCRIPTION OF THE PREFERRED EMBODIMENTS

With reference to the accompanying drawings, preferred embodiments of the present invention are described in detail below.

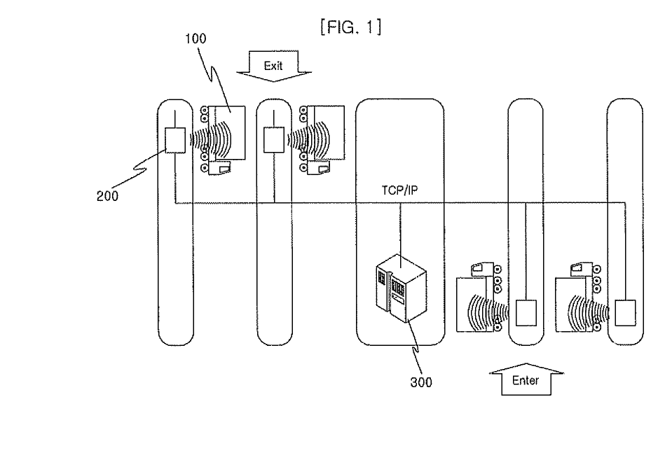

FIG. 1 is a diagram showing the construction of an RFID system capable of controlling a distance range according to an embodiment of the present invention. The system includes a plurality of RFID tags 100 for receiving position coordinates and time data through signals from a satellite and storing data, a plurality of readers 200 for transmitting and receiving data to and from the RFID tags 100, and middleware 300 configured to form a network in conjunction with the readers 200 and control a distance range between the RFID tags 100 and the readers 200.

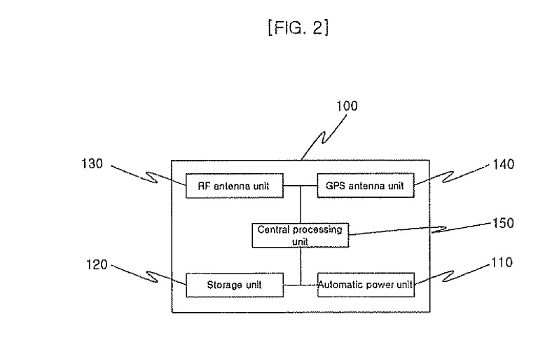

FIG. 2 is a detailed diagram showing an RFID tag according to the present invention. The RFID tag 100 includes an automatic power unit 110 for automatically supplying power, a GPS antenna unit 140 that receives power from the automatic power unit 110 and receives position coordinates and time data from a satellite, an RF antenna unit 130 for that receives power from the automatic power unit 110 and transmitting and receiving data to and from a reader 200, a central processing unit 150 for controlling and processing data transmitted and received through the GPS antenna unit 140 and the RF antenna unit 130, and a storage unit 120 for storing data processed by the central processing unit 150.

In more detail, when a time set by a user is reached or a signal is received from a reader 200, the automatic power unit 110 is switched from a sleep mode to an active mode, it automatically supplies power to the RFID tag 100, it is automatically switched from an active mode to a sleep mode, and then it cuts off power after the RFID tag 100 has performed all of its operations.

Accordingly, the automatic power unit 110 allows switching between a sleep mode and an active mode to be automatically performed based on the user's setting or the reader 200 itself, therefore unnecessary power consumption can be avoided, with the result that the life time of the RFID tag is increased.

When 80% or more of overall power is consumed, the automatic power unit 110 transmits notification data to the central processing unit 150 so as to pre-emptively prevent the erroneous operation of the RFID tag 100.

In particular, an operation of switching from a sleep mode to an active mode at a time set by the user and an operation of switching from a sleep mode to an active mode in response to a signal from the reader 200 are prioritized such that priority is given to a signal from the reader 200, and switching from a sleep mode to an active mode is performed first in response to the signal.

The GPS antenna unit 140 receives the position coordinates of the RFID tag 100 and time data from a satellite at the time set by the user, converts the received signals into data, and transmits the data to the central processing unit 150.

Accordingly, the GPS antenna unit 140 can be used when the RFID tag 100 fails or is lost, thereby accurately and rapidly analyzing the reason for the failure or loss of the RFID tag 100.

The RF antenna unit 130 includes an LE antenna 131 for receiving LF band signals and a UHF antenna 132 for receiving UHF band signals. The RF antenna unit 130 receives LF band signals or UHF band signals for switching to an active mode from the reader 200, receives and transmits the unique data of the RFID tag 100 via the UHF band, converts signals received by the LF antenna 131 and signals received by the UHF antenna into respective pieces of data, and transmits the data to the central processing unit 150.

Furthermore, the LF antenna 131 and UHF antenna 132 of the RF antenna unit 130 can selectively use signals for switching to an active mode in accordance with the environment and the purpose of use.

Preferably, the RF antenna unit 130 operates at a frequency of 125 KHz in the LE band and at a frequency of 433.92 MHz in the UHF band.

The central processing unit 150 filters and controls the position coordinates of the RFID tag 100 and time data, which are received from the GPS antenna unit 140, and the internal information data, departure place data, destination data, owner data and unloading site data, of the RFID tag 100, and processes the response results of the controlled data received from the RF antenna unit 130.

Furthermore, the central processing unit 150 compares the position coordinates and time data, which are received, converted and transmitted by the GPS antenna unit 140, with the position coordinates of the RFID tag 100 and time data, which were stored in advance, and filters them and then transmits them to the storage unit 120 if they are identical to each other, and switches a current mode from an active mode to a sleep mode and then automatically cuts off power if they are not identical to each other.

In particular, the central processing unit 150 controls the automatic power unit 110 so that it stands by in a sleep mode at normal times, and then switches to an active mode and automatically supplies or cuts off power to the RFID tag 100 when the time set by the user is reached, or when signals in the LF band or UHF band are received from the reader 200.

The storage unit 120 stores the unique data of the RFID tag 100 (internal information data, departure place data, destination data, owner data and unloading site data) in response to the input of the user, and receives the position coordinates of the RFID tag 100 and time data filtered and processed by the central processing unit 150, and stores the data in a queue.

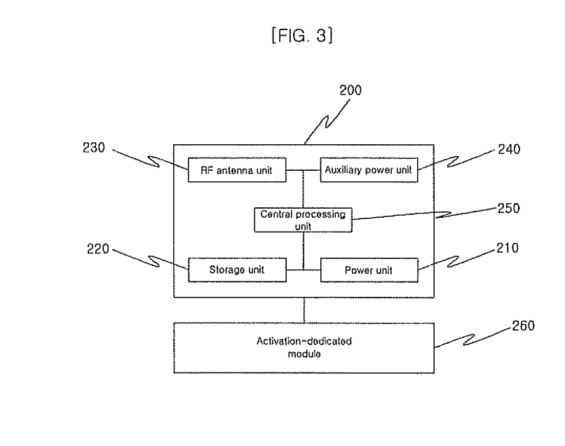

FIG. 3 is a detailed diagram of the reader 200 of FIG. 1 according to the present invention. The reader 200 includes an RF antenna unit 230 including an LF antenna for transmitting an activation signal to the RFID tag 100 via the LF band and a UHF antenna for transmitting and receiving an activation signal and data to and from the RFID tag 100 in the UHF band and configured to transmit and receive data via a dual band; a central processing unit 250 configured to control and process signals received from and transmitted to the RF antenna unit 230; a storage unit 220 configured to store data controlled and processed by the central processing unit 250; a power unit 210 for supplying power to the central processing unit 250 and the storage unit 220; and an auxiliary power unit 240 for making up for the shortage of power when the power of the power unit 210 is consumed.

The RF antenna unit 230 includes an LF antenna for transmitting LF band signals and a UHF antenna for transmitting and receiving UHF band signals. The RF antenna unit 230 receives a signal for switching to an active mode from the reader 200 via the LF band or UHF band, transmits and receives the unique data of the RFID tag 100 via the UHF band, converts signals received from the LF antenna 131 and the signals transmitted and received through the UHF antenna into data, and then transmits the data to the central processing unit 250.

The central processing unit 250 filters and controls the position coordinates of the RFID tag 100, time data, and the internal information data, departure place data, destination data, owner data and unloading site data of the RFID tag 100, which are received by the RF antenna unit 230, and processes response results of the controlled data.

The storage unit 220 stores the unique data (internal information data, departure place data, destination data, owner data and unloading site data) of the RFID tag 100 through the input of the user, or based on the data transmitted from the RFID tag 100.

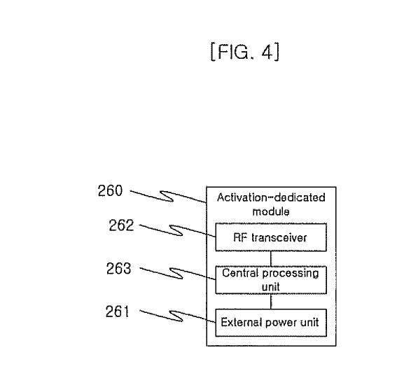

The activation-dedicated module 260, as shown in FIG. 4, includes an external power unit 261 connected to an external power source, an RF transceiver 262 for exclusively handing activation signals at high efficiency, and a central processing unit 263 configured to control the external power unit 261 and control and process data related to the RF transceiver.

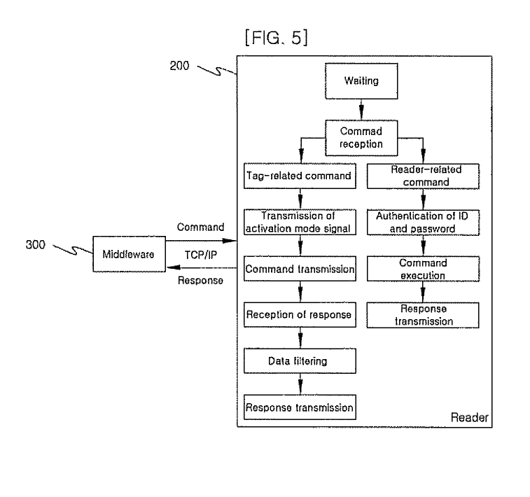

FIG. 5 is a diagram showing the operation of the middleware and the reader based on FIG. 3. When the middleware 300 transmits a command to the reader 200 via TCP/IP, the reader 200 receives the command of the middleware 300 and identifies whether the command is an RFID tag-related command or a reader-related command. If the command is an RFID tag-related command, the reader 200 transmits an activation signal to the RFID tag 100, transmits the command to the RFID tag 100 after the RFID tag 100 has been activated, receives and filters a response to the command, and then transmits the response to the middleware 300; if the command is a reader-related command, the reader 200 authenticates an ID and a password, executes the command of the middleware 300 if the authentication is successful, and then transmits a response to the command to the middleware 300.

The middleware 300 accesses the reader 200, which requires the control of RF output signals, via TCP/IP, undergoes an authentication procedure of inputting the ID and password of the reader 200, and transmits an RF output value setting command to the reader 200.

When the middleware 300 transmits the RF output value setting command to the reader 200, the reader 200 changes the RF output value and transmits the changed RF output value to the middleware 300.

Furthermore, it is determined whether the RF output value transmitted from the reader 200 is identical to the RF command value issued by the middleware 300. If they are identical to each other, an approval response is transmitted. In contrast, if they are not identical to each other, the determination of whether the RF command is identical to the RF output value is repeated two more times, and a rejection response is transmitted if the RF command is not identical to the RF output value for any of the three times.

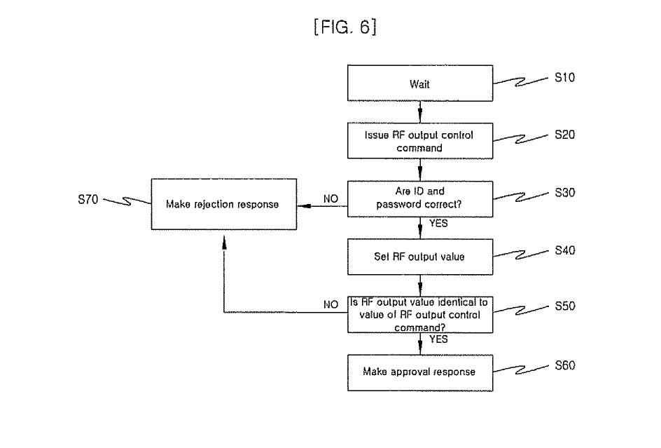

FIG. 6 is a flowchart showing a method of controlling distance ranges according to another embodiment of the present invention. This method includes a first step S10 of the reader 200 waiting for the execution of a command transmitted from the middleware 300, a second step S20 of the middleware 300 issuing an RF output control command to the reader 200, a third step S30 of authenticating the ID and password of the reader 200 so as to execute the RF output control command received from the middleware 300, a fourth step S40 of setting the RF output value of the reader 200 if the authentication is successful, a fifth step S50 of determining whether the set RF output value of the reader 200 is identical to the value of the RF output control command transmitted from the middleware 300, and a sixth step S60 of making an approval response if the RF output value of the reader 200 is identical to the value of the RF output control command transmitted from the middleware 300.

In more detail, at the first step S10, the reader 200 is waiting for the execution of a command transmitted from the middleware 300.

At the second step S20, the middleware 300 transmits an RF output value control command to one of the readers 200, for which the control of an RF output value is desired.

At the third step S30, the authentication of the ID and password of the reader 200 is performed so as to perform the RF output value control command issued to the reader 200 by the middleware 300 and prevent the attributes of the reader 200 from being changed by an unauthorized person.

At the fourth step S40, the reader 200 sets an RF output value based on the RF output value control command transmitted from the middleware 300 if the authentication is successful at the third step.

At the fifth step S50, whether the RF output value, which is obtained by the execution of the command of the middleware 300 by the reader 200, is identical to the value of the RF output control command transmitted from the middleware 300 is performed.

At the sixth step S60, an approval response is made because the value of the RF output control command issued by the middleware 300 is identical to the RF output value set by the reader 200, and the distance range between the reader 200 and the RFID tag 100 is optimally adjusted.

At the seventh step S70, the ID and password of the reader 200 are authenticated two more times if the authentication is not successful at the third step S30, and a rejection response is made if the authentication is not successful for any of the three times, or a rejection response is made if the RF output value of the reader 200 at the fifth step is not identical to the value of the RF output control value transmitted from the middleware 300.

As described above, according to the present invention, a plurality of readers are connected to a single piece of middleware via TCP/IP, the single piece of middleware transmits RF distance range control commands to the respective readers, and the readers can easily control and use the RF distance ranges thereof. Therefore, correct information can be obtained from RFID tags regardless of the environment of use, thereby considerably improving the performance of an RFID system.

Although the preferred embodiments of the present invention have been disclosed for illustrative purposes, those skilled in the art will appreciate that various modifications, additions and substitutions are possible, without departing from the scope and spirit of the present invention as disclosed in the accompanying claims.

What is claimed is:

1. A Radio Frequency Identification (RFID) system for controlling distance ranges, comprising:
a plurality of RFID tags for receiving position coordinates and time data through signals from a satellite and storing data;
a plurality of readers for transmitting and receiving data to and from the RFID tags; and
middleware configured to form a network in conjunction with the readers and control distance ranges between the RFID tags and the readers.

2. The RFID system as set forth in claim 1, wherein each of the RFID tags comprises:
a GPS antenna unit that receives position coordinates and time data from a satellite;
an RF antenna unit comprising an LF antenna for receiving activation signals from the readers via an LF band and a UHF antenna for transmitting and receiving activation signals and data via a UHF band, and configured to transmit and receive data via a dual band;
an automatic power unit for automatically supplying and cutting off power in response to the activation signals received by the LF antenna or UHF antenna of the RF antenna unit;
a central processing unit configured to be supplied with power by the automatic power unit and to control the GPS antenna unit and the RF antenna unit; and
a storage unit for storing data controlled and processed by the central processing unit.

3. The RFID system as set forth in claim 2, wherein the automatic power unit of the RFID tag operates in a sleep mode at normal times, is switched to an active mode at a time set by a user, and then automatically supplies and cuts off power.

4. The RFID system as set forth in claim 2, wherein the automatic power unit of the RFID tag operates in a sleep mode at normal times, is switched to an active mode in response to a signal received from the reader, and then automatically supplies and cuts off power.

5. The RFID system as set forth in claim 1, wherein each of the readers comprises:
an RF antenna unit comprising an LF antenna for transmitting an activation signal to the RFID tag via an LF band and a UHF antenna for exchanging an activation signal and data with the RFID tag via a UHF band, and configured to transmit and receive data via a dual band;
a central processing unit for controlling and processing the signals transmitted from and received by the RF antenna unit;
a storage unit for storing data controlled and processed by the central processing unit;
a power unit for supplying power to the RF antenna unit, the central processing unit and the storage unit; and
an auxiliary power unit for supplying power in an auxiliary manner when the power of the power unit is consumed.

6. The RFID system as set forth in claim 5, wherein each of the readers further comprises an activation-dedicated module for exchanging activation signals with the RFID tag.

7. A method of controlling distance ranges, comprising:
a first step of a reader waiting for execution of a command transmitted from middleware;
a second step of the middleware issuing an RF output control command to the reader;
a third step of authenticating an ID and password of the reader so as to execute the RF output control command received from the middleware;
a fourth step of setting an RF output value of the reader if the authentication is successful;
a fifth step of determining whether the set RF output value of the reader is identical to a value of the RF output control command transmitted from the middleware; and
a sixth step of making an approval response if the RF output value of the reader is identical to the value of the RF output control command transmitted from the middleware.

8. The method set forth in claim 7, further comprising a seventh step of making a rejection response if the authentication is not successful at the third step.

9. The method set forth in claim 7, further comprising an eighth step of making a rejection response if the RF output value of the reader is not identical to the value of the RF output control command transmitted from the middleware at the fifth step.
